(19) United States
(12) Patent Application Publication
(10) Pub. No.: US 2008/0236920 A1
(43) Pub. Date: Oct. 2, 2008

(54) All-electric motor car

(76) Inventors: Edward LeRoy Swindell, Key Largo, FL (US); Stephen Galatti, Millbrook, NY (US)

Correspondence Address: Edward LeRoy Swindell, 24 Dockside Lane, P.M.B. 376, Key Largo, FL, 33037, US

(21) Appl. No.: 11/728,638

(22) Filed: Mar. 27, 2007

(51) Int. Cl. B60K 8/00

(52) U.S. Cl. 180/165

(57) ABSTRACT

Our invention is a four wheel, multi-speed, all-electric motor car, used to move personnel and powered by one or in the alternative two multi-wound three phase alternating current motor(s). The forward and reverse direction of the vehicle is accomplished by moving a forward and reverse switch before starting the vehicle by engaging the operating switch. The electrical supply for the vehicle is both direct and alternating current. The conversion of the direct current to alternating current is accomplished by an inverter with direct current (from the batteries) in to the inverter, and alternating current out. The electrical supply for the vehicle is furnished by batteries charged by a stand-by rectifier or plug-in socket when the vehicle is not in use, and with solar panel and fuel cells interfacing during daytime operation. The removable batteries and hydrogen tanks at exchange stations, if so desired by the operator of the vehicle, adds to the many aptitudes of this motor car.

### BACKGROUND OF THE INVENTION

The specific field of the invention is an all-electric motor car resembling the size, weight and shape of most of the modern cars, but this vehicle takes a unique step forward in its utilizing a new three phase electrical system in electric car designs consisting of the multi-wound three phase motor or motors.

### SUMMARY OF THE INVENTION

This electric vehicle's motor starts the vehicle at low speed in the “star”, or “y” position, and makes a transition to the “delta” “Δ” position as the speed of the vehicle increases. The low position gives the high torque at the low speed and the high position gives low torque at the high speed. The alternating current permits battery recharging from any outlet source when the vehicle is at rest and continual “trickle” charging via the solar panel or fuel cell while the vehicle is in motion, thus permitting virtual limitless travel.

### BRIEF DESCRIPTION OF THE DRAWINGS

The accompanying drawings show an embodiment of our inventions and modification of a side view of the longitudinal section of the vehicle.

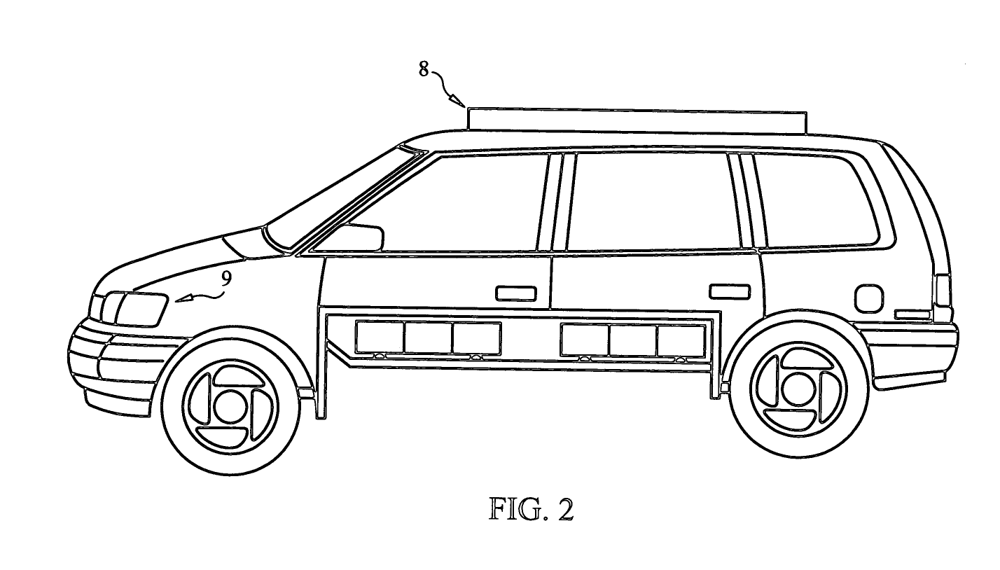

(FIG. 2) shows a fuel cell (9) and a solar panel (8) on the roof of the vehicle with traction battery (4).

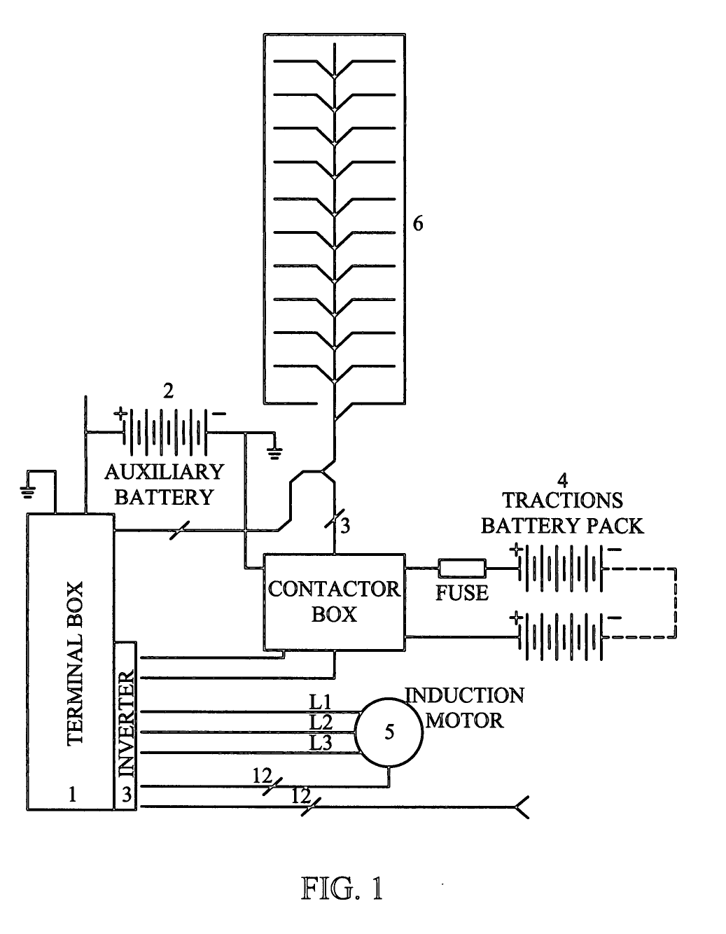

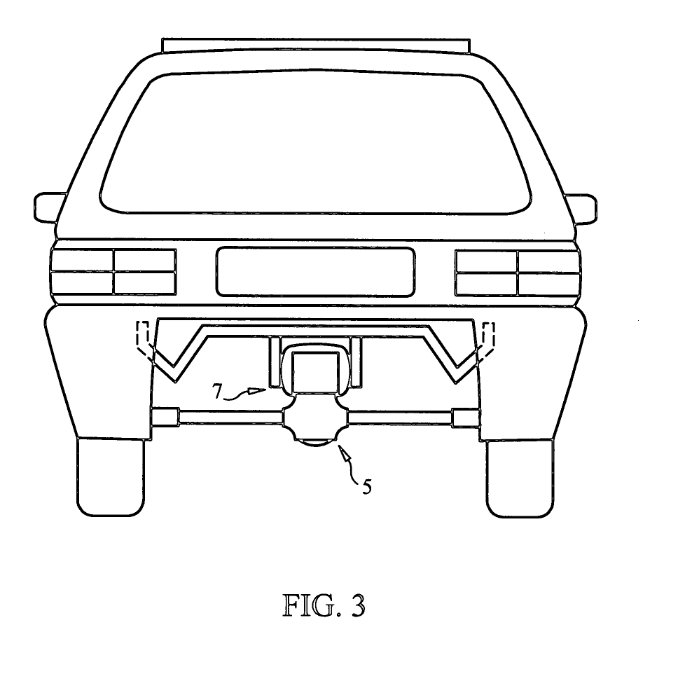

(FIG. 1) and (FIG. 3) show the three phase motor (5) shaft and gear box (7). The Index item reference shown on (FIG. 1) is a wiring diagram with connections to the inverter (1). The inverter changes the motor connection from the “start-star” connection to the “run-delta” connection.

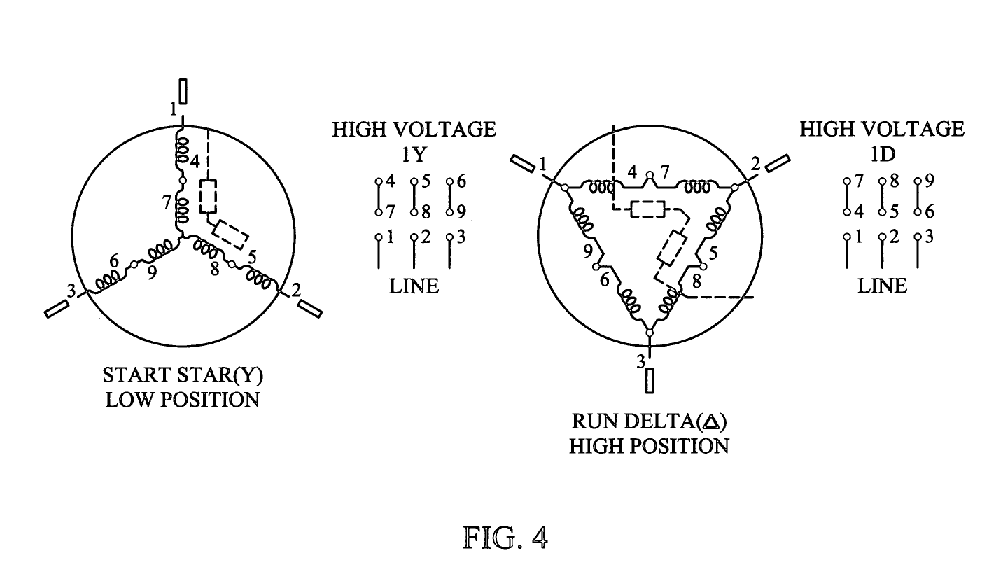

(FIG. 4) diagram shows the electrical connection for the “HIGH” and “LOW” positions of the three phase motor. The inverter has a three pole, double throw provision, which changes the HIGH and LOW positions connection to the motor.

The charging diversity with the use of solar panels, a fuel cell and a “plug-in” capacity adds to the great distance which can be achieved prior to any necessary recharging of the vehicle. The thirty minute charge ability relative to the latest battery developments add to the versatility of this vehicles charging cycle.

1. An all-electric motor car powered by one three phase electric motor with dual windings connected electrically as set forth in (FIG. 4) mounted on the drive shaft attached to a gear box in tandem the electric energy to which is supplied by batteries fuel cells and solar panels with plug-in provision.

2. An all-electric motor car described in claim 1 above but with two 3 phase motors mounted in tandem on the rear axle of the motor car.

3. A battery and tank exchange system in which fully charged batteries and/or hydrogen tanks can be exchanged at designated stations en route for depleted ones of universal design and which are mutually interchangeable on line-of-road and the system being completely compatible with claims 1 and 2.
